(19) United States
(12) Patent Application Publication
(10) Pub. No.: US 2021/0154601 A1
(43) Pub. Date: May 27, 2021

(54) SAND SEPARATOR WITH GAS VENT

(71) Applicant: Sand Separation Technologies Inc., Acheson (CA)

(72) Inventors: Chris Michael Johnston, St. Albert (CA); Mohsen Bayati, Calgary (CA)

(21) Appl. No.: 17/100,164

(22) Filed: Nov. 20, 2020

Related U.S. Application Data
(60) Provisional application No. 62/938,760, filed on Nov. 21, 2019.

(51) Int. Cl. B01D 21/26; B01D 19/00

(52) U.S. Cl. CPC B01D 21/267; B01D 19/0057

(57) ABSTRACT

A separator for separating solid matter and gas from a fluid flow includes a vessel having an inlet, a fluid outlet, and a gas outlet. The fluid outlet is spaced below the inlet. The separator further includes an enclosure disposed between the inlet and the fluid outlet that redirects the fluid stream passing from the inlet to the fluid outlet. The enclosure defines an inner cavity above a lower edge of the enclosure, and the lower edge defines a fluid flow area. The fluid outlet is disposed within the inner cavity at a height that is above the lower edge of the enclosure and the gas outlet is disposed with a gas space defined by the enclosure.

### BACKGROUND

### Technical Field

This relates to a separator for separating solids from a multiphase fluid stream, and in particular, a separator with a gas outlet to vent gas pressure.

### Description of the Related Art

Sand separators are commonly used in oil and gas operations, such as to remove sand from a production stream from a hydrocarbon well. The term “sand” is generally used in such contexts to refer to particulate solids entrained in the production stream. In addition to the particulate solids, such a production stream are commonly made up of a gas or vapor phase, water, and liquid hydrocarbons, although other components may also be present. U.S. Pat. No. 9,089,792 (Zylla) entitled “Multi-phase flow separation apparatus and system” describes a separator used to separate sand from a multi-phase fluid flow.

### BRIEF SUMMARY

According to an aspect, there is provided a separator for separating solid matter and gas from a fluid flow comprising a vessel having an inlet, a fluid outlet, and a gas outlet, the fluid outlet being spaced below the inlet and an enclosure disposed between the inlet and the fluid outlet that redirects the fluid stream passing from the inlet to the fluid outlet, the enclosure defining an inner cavity above a lower edge of the enclosure, the lower edge defining a fluid flow area, wherein the fluid outlet is disposed within the inner cavity at a height that is above the lower edge of the enclosure and the gas outlet is disposed within a gas space defined by the enclosure

According to other aspects, the separator may comprise one or more of the following features, alone or in combination: the gas outlet may be disposed within the enclosure and above the fluid outlet; the gas outlet may be disposed outside the enclosure and above the lower edge of the enclosure; the separator may comprise a first gas outlet outside the enclosure and above the lower edge of the enclosure, and a second gas outlet within the enclosure and above the fluid outlet; the separator may comprise one or more vanes extending along at least a portion of an outer surface of the enclosure, the one or more vanes may redirect the fluid stream along a curved flow path as the fluid stream flows toward the lower edge; the gas outlet may comprise a check valve that opens when a predetermined pressure inside the vessel has been reached; and the gas outlet may comprise a choke valve that opens and closes to control a pressure within the vessel.

In other aspects, the features described above may be combined together in any reasonable combination as will be recognized by those skilled in the art.

### BRIEF DESCRIPTION OF THE SEVERAL VIEWS OF THE DRAWINGS

These and other features will become more apparent from the following description in which reference is made to the appended drawings, the drawings are for the purpose of illustration only and are not intended to be in any way limiting, wherein:

FIG. 1 is an elevation side view in cross section of a separator with a gas outlet.

FIG. 2 is an elevation side view in cross section of a separator with a gas outlet disposed within an enclosure.

FIG. 3 is an elevation side view in cross section of a separator with two gas outlets.

FIG. 4 is an elevation side view in cross section of an alternative separator.

FIG. 5 is an elevation side view in cross section of a separator that uses a vertical cylindrical vessel.

### DETAILED DESCRIPTION

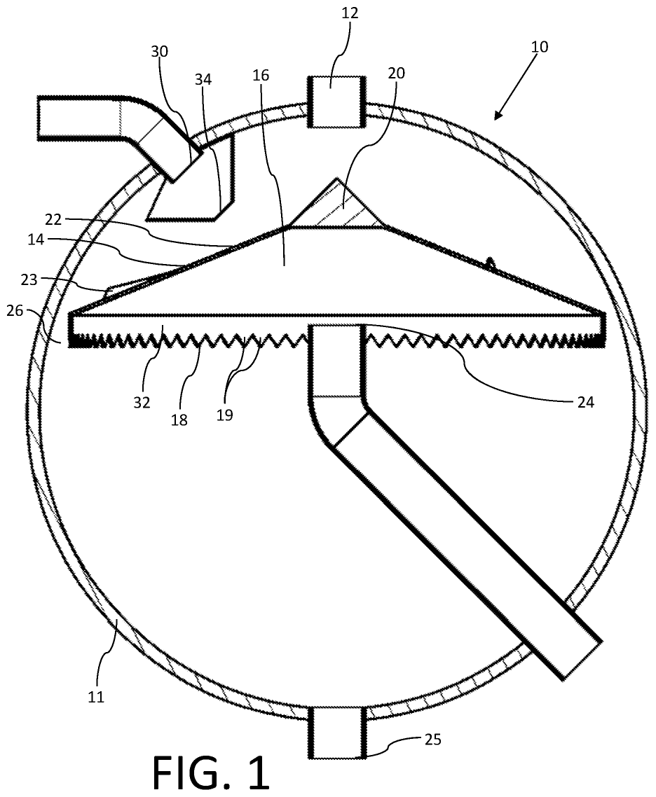

A separator, generally identified by reference number 10, will now be described with respect to FIG. 1 to FIG. 5.

Separator 10 is designed to use gravity and preferably centrifugal force to assist in the separation of sand from a fluid stream. Sand is a term used here to describe solid particulates that are entrained in the fluid stream. The sand may be naturally occurring or introduced due to human activities such as hydraulic fracturing, commonly referred to as fracking. The fluid stream also includes gas and liquid phases, which will generally be water-based and/or hydrocarbon-based.

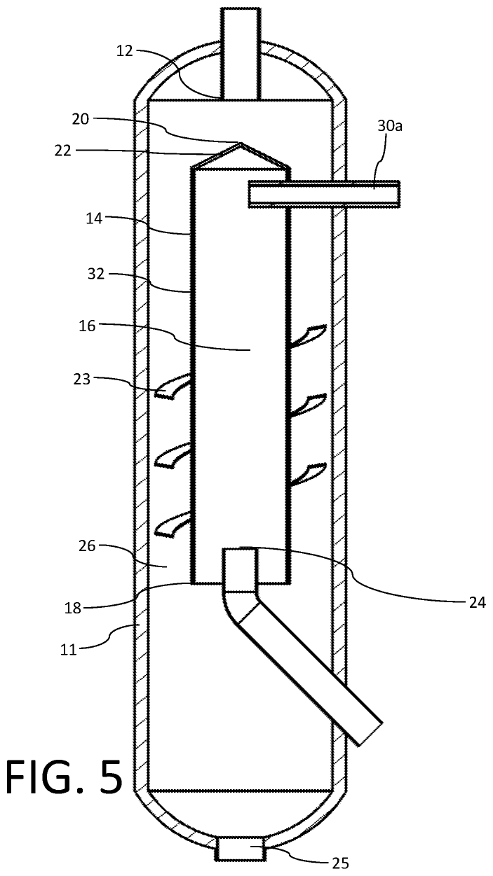

Referring to FIG. 1, separator 10 includes a vessel 11 that has an inlet 12 through which fluid enters the vessel, and a fluid outlet 24 spaced below inlet 12 through which fluid exits the vessel. Sand that separates from the fluid flow collects at the bottom of vessel 11, and is preferably removed via a sand outlet 25. Inspection ports (not shown) may also be provided to provide visual inspection of the inside of vessel 11. Vessel 11 may be spherical, as shown in FIG. 1 to FIG. 4, cylindrical, as shown in FIG. 5, or any other suitable shape.

A fluid stream to be separated is fed into vessel 11 from a fluid source (not shown), such as a well, production pipe line, or pump, via inlet 12. Inlet 12 may be connected to the fluid source using various connections. As shown, inlet 12 includes a drop pipe that extends into vessel 11. There may be a flange on the outside of vessel 11 to facilitate the connection to the fluid supply, however other methods of connection may be used. Inlet 12 may extend into the vessel as shown or may be flush with the inner sidewall of vessel 11. In some examples, a nozzle may be attached or incorporated into inlet 12. If present, the nozzle is preferably made of wear resistant material to reduce the abrasive effects of the sand. The nozzle would be used to assist inlet 12 in directing the fluid stream into the vessel 11.

Separator 10 has an enclosure 14 disposed between inlet 12 and fluid outlet 24. Enclosure 14 opens downward and defines an inner cavity 16 above a lower edge 18 of enclosure 14. While enclosure 14 may take different shapes, the depicted enclosure 14 is a cone that opens downward, with a skirt-like ring 32 that extends down to define lower edge 18. Lower edge 18 of enclosure 14 defines a fluid flow area 26 through which the fluid stream must pass to reach fluid outlet 24. Fluid outlet 24 is in communication with inner cavity 16 of enclosure 14 such that fluid from within enclosure 14 enters fluid outlet 24. As depicted, lower edge 18 extends below fluid outlet 24, such that the liquid level rises within enclosure 14 to reach outlet 24. Other configurations may be possible, as long as fluid outlet 24 draws fluid from within enclosure 14. As shown, lower edge 18 may have triangular teeth 19 adjacent to fluid flow area 26 that cause turbulence within the fluid stream to assist with separating the solid, liquids, and gas from the fluid stream.

Enclosure 14 may have a top portion 20 that is shaped to divert the fluid stream over a top surface 22 of enclosure 14. Top portion 20 may be made from a wear resistant material and may be removable to allow access into inner cavity 16 or to be replaceable. The outer surface of enclosure 14 may have one or more vanes 23 that direct the fluid stream along a curved path as the fluid stream flows toward lower edge 18 of enclosure 14. As shown, vanes 23 direct the fluid stream along a curved path in order to create a fluid vortex within vessel 12, however vanes 23 may be shaped to create different fluid flow paths.

Referring to FIG. 1, separator 10 has a gas outlet 30 that is positioned outside enclosure 14 and in a gas space above the expected fluid level, which will generally be defined by the bottom edge 18 of enclosure 14. Preferably, gas outlet 30 is designed to reduce the amount of liquid that enters gas outlet 30. As shown in FIG. 1, gas outlet 30 is covered by a hood 34, which requires gas to change directions to reach outlet 30 to encourage liquids and solids to fall out of the gas stream prior to reaching outlet 30.

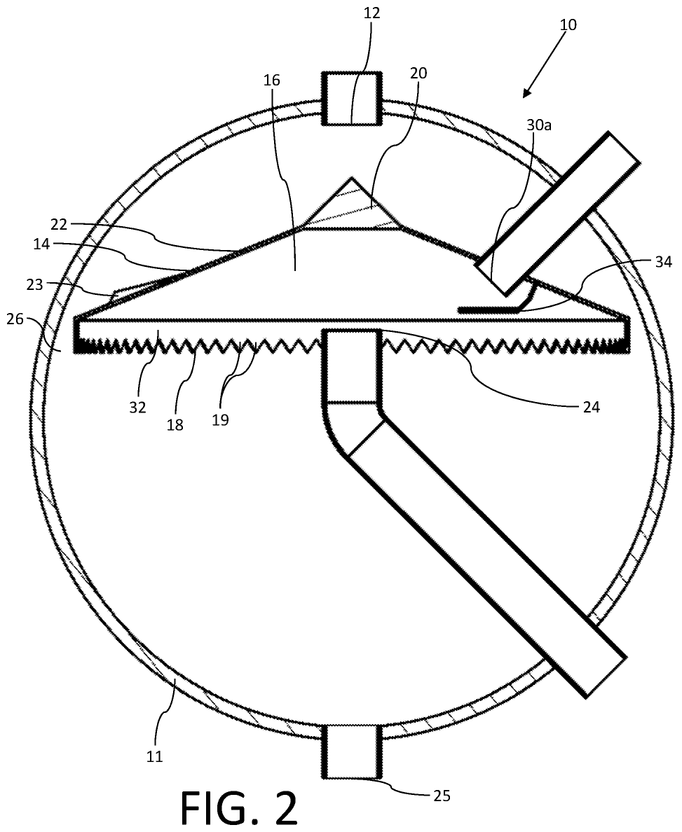

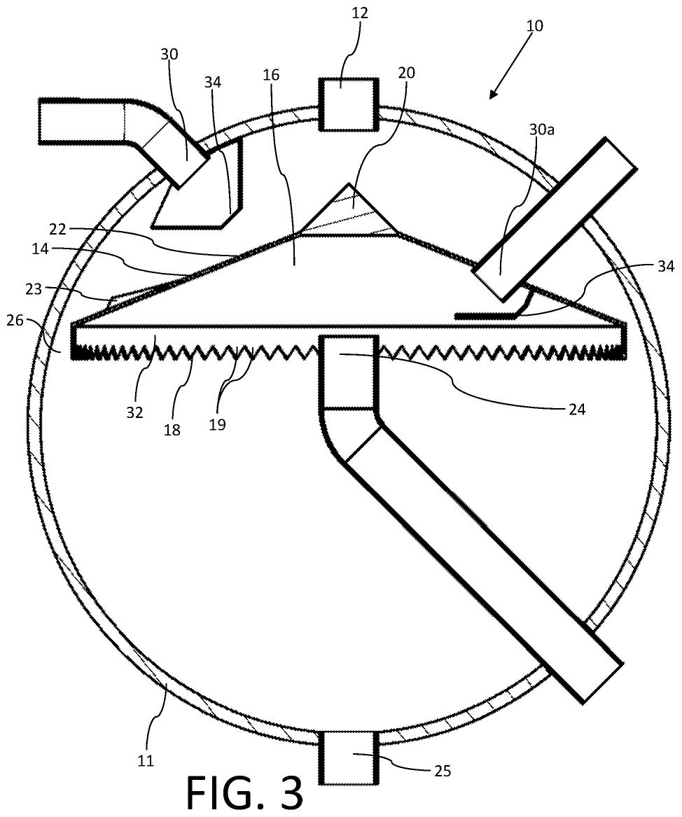

Referring to FIG. 2, a gas outlet 30a may be positioned within cavity 16 of enclosure 14 in a gas space above the expected fluid level within enclosure 14. While the expected fluid level is generally defined by the bottom edge of 18 of enclosure 14, it may change based on the conditions inside vessel 12, such as a fluid flow rate from inlet 12, or a gas pressure within the gas space either above or below enclosure 14. Furthermore, the fluid level within enclosure 14 may be different from the fluid level outside of enclosure 14. Gas outlet 30a may be an alternative to gas outlet 30 or in addition to gas outlet 30, as shown in FIG. 3. In FIG. 5, which shows vessel 11 as a vertical cylinder rather than a spherical vessel as in FIGS. 1-4, gas outlet 30a is provided within enclosure 14, although it will be understood that gas outlet 30 may be provided in addition, or as an alternative, to gas outlet 30a.

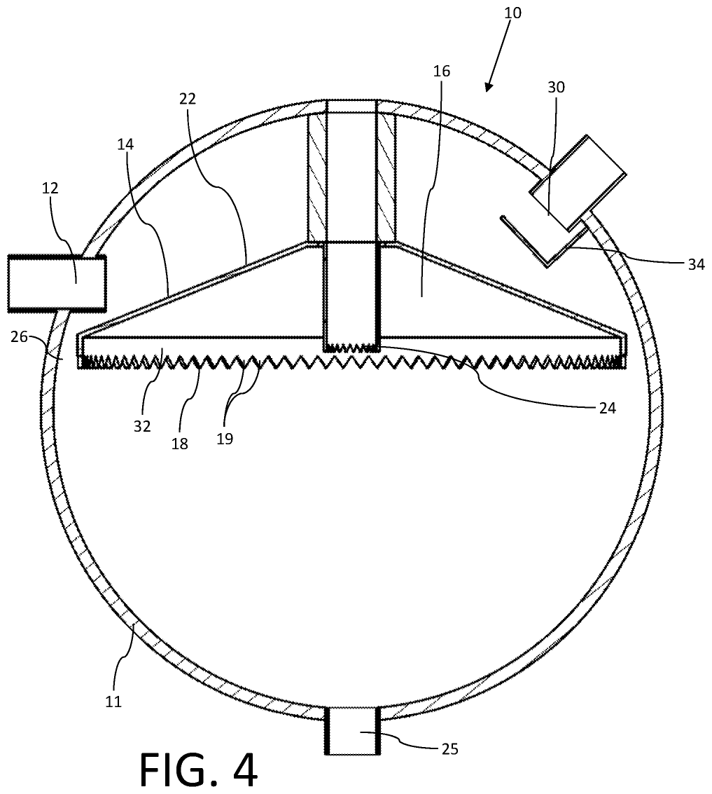

The position and direction of inlets and outlets within vessel 11 may vary, some examples of which are shown in FIG. 4. As shown, inlet 12 is oriented horizontally, and may be offset from the central axis, such that the fluid velocity induces fluid rotation. Fluid outlet 24 is located within enclosure 14, but extends vertically upward, such that fluid pressure within vessel 11 must be sufficient to cause fluid to exit out the top of vessel 11, rather than downward as is the case in FIG. 1, for example.

The flow through gas outlets 30, 30a may be controlled to maintain a desired fluid characteristics within vessel 11. For example, gas outlets 30, 30a may be controlled to maintain the pressure within vessel 11 to within a predetermined range, such as by using control valves such as check valves, a choke valve, or other flow control devices well known in the art. Gas outlets 30, 30a may also be controlled to maintain a desired liquid/gas ratio within vessel 11, to maintain a rate of fluid flow through vessel 11, or to maintain a vapor lock. Inlet 12, fluid outlet 24, and sand outlet 25 may also be equipped with flow control elements, such as valves, P-traps, or other devices, to allow for further control of the various characteristics as described above. Separator 10 may also have sensors or switches that are used to determine fluid characteristics.

Separator may have additional elements not shown, such as baffles or vortex breakers, to further enhance the separation of the solids, liquids, and gas in the fluid stream. Some examples of these additional features may be found in PCT Patent Application Publication No. 2019/056112, which is incorporated herein by reference.

As the multiphase flow enters vessel 11 via inlet 12, it will first strike the top surface of enclosure 14 and an initial separation will occur. Due to fluid pressure above enclosure 14, gas and liquid will be forced under bottom edge 18 and into enclosure 14. Liquid and/or gas are then withdrawn via fluid outlet 24. Throughout the flow path of the liquid and gas phases, sand is encouraged to drop out of the fluid flow, and is collected at the bottom of vessel 11, where it is eventually removed using known techniques and vessel designs, the details of which are not shown. In order to reduce the pressure within vessel 11, gas outlets 30 and/or 30a may be provided to remove a stream of fluid that is primarily gas. The degree of separation of liquid and gas at these outlets will depend on the preferences of the user and the particular circumstances of use. In some examples, the fluid that exits vessel 11 through gas outlet 30 may be a “wet gas” that either carries some entrained liquid or includes vapor components that may readily condense when the stream is subjected to a change in pressure or temperature. Depending on the circumstances of use, the flows from fluid outlet 24 and gas outlet 30 may be combined downstream of separator 10, in which case it may be acceptable for a larger portion of liquid to exit through gas outlet 30, as long as pressure is reduced within vessel 11 and any significant amount of sand is prevented from exiting through gas outlet 30.

Referring to FIG. 1, gas outlet 30 may be used to relieve fluid pressure outside enclosure 14, while referring to FIG. 2, gas outlet 30a may be used to relieve fluid pressure within enclosure 14. Either or both may be used, as shown in FIG. 3. In each case, withdrawing a fluid stream via gas outlet 30 and/or 30a will reduce the pressure within vessel 11 and slow the flow rate through vessel 11, allowing additional sand to fall out. The fluid flow through outlet 24 may include both gas and liquid, although the components will depend on the amount of gas removed via outlets 30 and/or 30a. Downstream of vessel 11, gas outlet 30 and fluid outlet 24 may be recombined into a single flow stream, into a gas/liquid separator vessel, or may be treated separately, based on the preferences of the user or the particular circumstances in which separator 10 is used.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

The various embodiments described above can be combined to provide further embodiments. All of the U.S. and foreign patents, applications, and publications referred to in this specification and/or listed in the Application Data Sheet are incorporated herein by reference, in their entirety. Aspects of the embodiments can be modified, if necessary to employ concepts of the various patents, applications and publications to provide yet further embodiments. These and other changes can be made to the embodiments in light of the above-detailed description. Accordingly, the claims are not limited by the disclosure.

1. A separator for separating solid matter from a fluid flow, comprising:
a vessel having an inlet, a fluid outlet, and a gas outlet, the fluid outlet being spaced below the inlet; and
an enclosure disposed between the inlet and the fluid outlet that redirects the fluid stream passing from the inlet to the fluid outlet, the enclosure defining an inner cavity above a lower edge of the enclosure, the lower edge defining a fluid flow area;
wherein:
the fluid outlet is in communication with the enclosure such that the fluid outlet draws fluid from within the enclosure; and
the gas outlet is disposed within a gas space defined by the enclosure.

2. The separator of claim 1, wherein the gas outlet is disposed within the enclosure and above the fluid outlet.

3. The separator of claim 1, wherein the gas outlet is disposed outside the enclosure and above the lower edge of the enclosure.

4. The separator of claim 1, comprising a first gas outlet outside the enclosure and above the lower edge of the enclosure, and a second gas outlet within the enclosure and above the fluid outlet.

5. The separator of claim 1, wherein the gas outlet comprises a control valve used to control characteristics of the fluid within the vessel.
